(19) United States
(12) Patent Application Publication
(10) Pub. No.: US 2006/0200991 A1
(43) Pub. Date: Sep. 14, 2006

(54) Hair trimmer

(75) Inventor: Sik-Leung Chan, Tsuen Wan (CN)

Correspondence Address: Daniel P. Burke, Esq.;GALGANO & BURKE, LLP, Suite 135, 300 Rabro Drive, Hauppauge, NY, 11788, US

(73) Assignee: C.C. & L COMPANY LIMITED

(21) Appl. No.: 11/156,415

(22) Filed: Jun. 20, 2005

Related U.S. Application Data
(60) Provisional application No. 60/661,645, filed on Mar. 14, 2005.

(51) Int. Cl. B26B 19/00

(52) U.S. Cl. 30/29.5

(57) ABSTRACT

Hair trimmers, for example hair trimmers particularly suited for trimming nose hair. One aspect includes at least one movable blade and at least one shell having an interior surfaces at least one hole extending through the shell, and an interior cutting edge. The movable blade is hingedly connected to a movable blade hinge comprising a longitudinal axis. The shell, movable blade hinge and movable blade are positioned such that the cutting edge of the blade travels close to or along a portion of the interior surface of the shell and precedes the hinge such that resistance to the movement of the blade edge, such as that provided by a hair contacting the blade edge, will tend to wedge the blade more tightly between the hinge and the shell thereby increasing the contact pressure between the movable blade and the stationary surface. The cutting edge can also be urged toward the interior surface by centrifugal force.

### RELATED APPLICATION DATA

This application claims the benefit of related U.S. Provisional Patent Application Ser. No. 60/661,645 filed on Mar. 14, 2005.

The present invention is directed to a hair trimmer and is particularly suited for use as a nose hair trimmer.

### BACKGROUND

Various devices have been previously disclosed for trimming hair including, for example, nose hair trimmers. Previously disclosed nose hair trimmers include devices having one or more openings through which hairs can extend into an area where they are cut. Some previous devices include movable blades driven by rotary motors which act in cooperation with stationary surfaces defining cutting areas to cut hair extending into the cutting areas. Those skilled in the art will appreciate that as movable blades are used for cutting, their cutting edges will tend to become dull over time due to the contact between the cutting edge of the movable blade relative to a static cutter. Some prior art devices rely upon springs to provide constant contact pressure between a rotating cutter and a static cutter. The constant contact pressure between the two cutters, even at times when hair is not being cut, tends to decrease the useful life of the blades. Therefore, it would be desirable to minimize the contact and/or the contact pressure between a movable blade and a stationary surface which cooperates with the movable cutting edge during a cutting step, particularly when hair is not being cut.

It would also be desirable to provide a hair cutter which minimizes the contact and/or the contact pressure between a movable blade and a stationary cutting surface, at least when the blade is not cutting hair.

It would further be desirable to provide a hair cutter with increased blade life and which decreases the amount of noise generated when the blades are moving.

It would be particularly useful to provide a hair cutter, for example, a nose hair trimmer, which minimizes the contact and/or the contact pressure between at least one movable blade and at least one other surface when the blade is moving but not cutting hair. It is also desirable to provide a hair cutter which increases the contact pressure between a movable blade and a stationary surface when the cutting edge of the blade encounters resistance, such as when the blade edge encounters hair.

### SUMMARY OF THE INVENTION

Various embodiments of the present invention comprise hair trimmers, for example hair trimmers particularly suited for trimming nose hair, comprising at least one movable blade and at least one shell having an interior surface, at least one hole extending through the shell, and an interior cutting edge. The movable blade is hingedly connected to a movable blade hinge comprising a longitudinal axis. The blade hinge is moved in a manner such that the longitudinal axis moves along a path, preferably a circular path, thereby urging a movable cutting edge of the movable blade into contact with the interior cutting edge of the shell.

The shell, movable blade hinge and movable blade are positioned such that the cutting edge of the blade travels close to or along a portion of the interior surface of the shell and precedes the hinge such that resistance to the movement of the blade edge, such as that provided by a hair contacting the blade edge, will tend to wedge the blade more tightly between the hinge and the shell thereby increasing the contact pressure between the movable blade and the stationary surface.

According to one preferred embodiment of the present invention, at least one blade has a cutting edge which contacts the cooperating cutting surface of the shell forwardly (in a rotational direction) of the center of gravity of the movable blade. This results in an increased cutting pressure applied between the rotating blade and the cooperating stationary shell caused by a wedging action of the rotating blade into the hair or whiskers being cut.

Various embodiments of the present invention utilize one or more blades hingedly connected to a movable blade hinge. As used herein, the term “hinge” and its various forms are used to indicate that the position of the cutting edge of the movable blade is not fixed relative to the movable blade support. As described in further detail below, the movable blade support can be fairly described as a hinge support, including but not limited to a movable shaft on which the movable blade is freely rotatable. The hinge connection between one or more movable blades and the respective blade supports can be mechanical and/or can take the form of a living hinge which relies upon the flexibility and/or resiliency of material used to manufacture one or more of the elements of the device, such as the movable blade support or the movable blade.

### BRIEF DESCRIPTION OF THE DRAWINGS

FIG. 1 is an exploded view of one preferred embodiment of the present invention in the form of a nose hair trimmer.

FIG. 2 is an assembled view of the nose hair trimmer illustrated in FIG. 1.

FIG. 3 is a top plan view of the hair cutter shown in FIG. 1.

FIG. 4 illustrates another embodiment of the present invention in the form of a multi-cutter comprising three movable blades in a single shell.

FIGS. 5-8 illustrate another embodiment of the present invention in the form of a multi-blade shaver.

FIG. 9 illustrates a further embodiment of the present invention wherein the cutting edge of a movable blade is not parallel to the longitudinal axis of the blade support.

FIG. 10 illustrates an alternative embodiment of the present invention comprising a segmented stationary cutter assembly.

FIG. 11 illustrates a still further embodiment of the present invention comprising a resilient blade support.

### DETAILED DESCRIPTION

Various embodiments of the present invention are directed to hair cutters comprising at least one movable blade connected to a movable blade support. The devices of the present invention also comprise a stationary blade which can be in the form of a shell within which the movable blade is moved. For purposes of cutting hair it is important that there is relative movement between the cutting edge of the movable blade and the stationary blade. While in the preferred embodiments described herein, the “stationary” surface is actually stationary relative to the hand of the person shaving or a housing on the motor, according to other embodiments the surface and/or cutting edges which cooperate with the movable blade can be movable either in a direction opposite to movement of the movable blade or in the same direction but at a slower rate. Therefore, as used herein, the term “stationary blade” is used to indicate a surface comprising at least one edge which is relatively movable to, and acts in cooperation with, the edge of the movable blade to cut hair.

In each of the embodiments of the present invention described below, at least one movable blade is moved relative to a cooperating cutting surface or edge while centrifugal force is applied to the movable blade in the direction of the cooperating surface or edge. The cutting edge of the movable blade is positioned such that when resistance to its movement is encountered, for example by a hair, a wedging action will result tending to cause contact or, more preferably, to increase the contact pressure between the movable blade and the cooperating stationary blade.

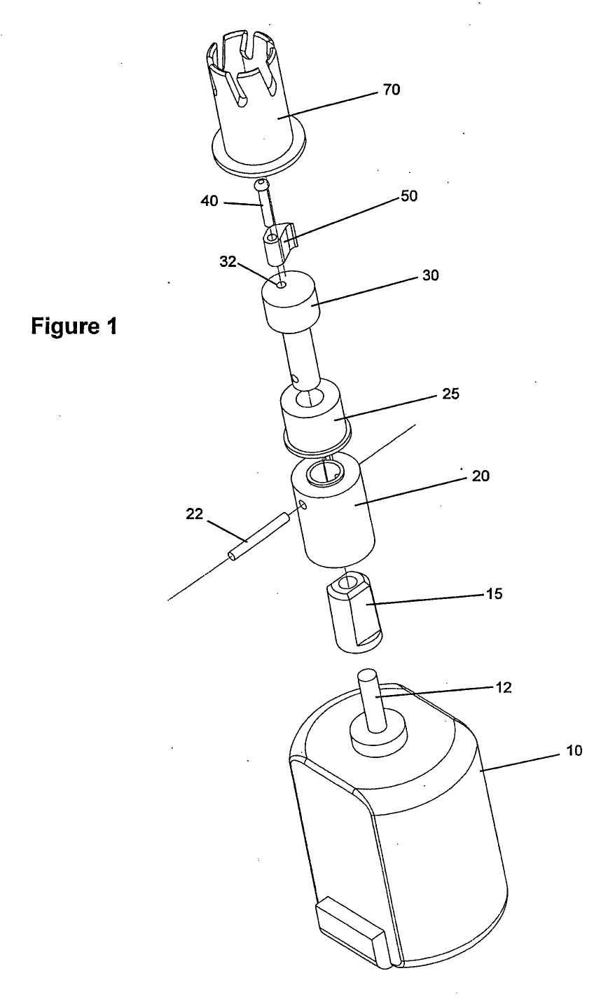

One preferred embodiment of the present invention is in the form of a nose hair trimmer and is illustrated in FIGS. 1-3. This illustrated nose hair trimmer comprises an electric motor 10 having a rotatable motor shaft 12, a motor coupling 15, a rotor coupling 20, a bearing 25, a rotor 30 which is fixed to a rotor coupling 20 with rotor fixing pin 22. Rotor 30 which is rotated through the cooperation of the various parts and driven by motor 10, comprises an eccentrically mounted blade support connector 32. In this illustrated embodiment, blade support connector 32 is advantageously in the form of an eccentrically mounted bore dimensioned to securely receive a movable blade support 40 in the form of a shaft. A rotating blade 50 is movably supported on movable blade support 40 within a stationary blade 70. Though not shown, the devices of the present invention can have suitable controls such as on/off switches and additional switches, knobs, or the like to control the rotational speed of the motor. Those skilled in the art will appreciate that as the motor speed is increased, the centrifugal force of the cutting edge on the interior surface of the shell will increase.

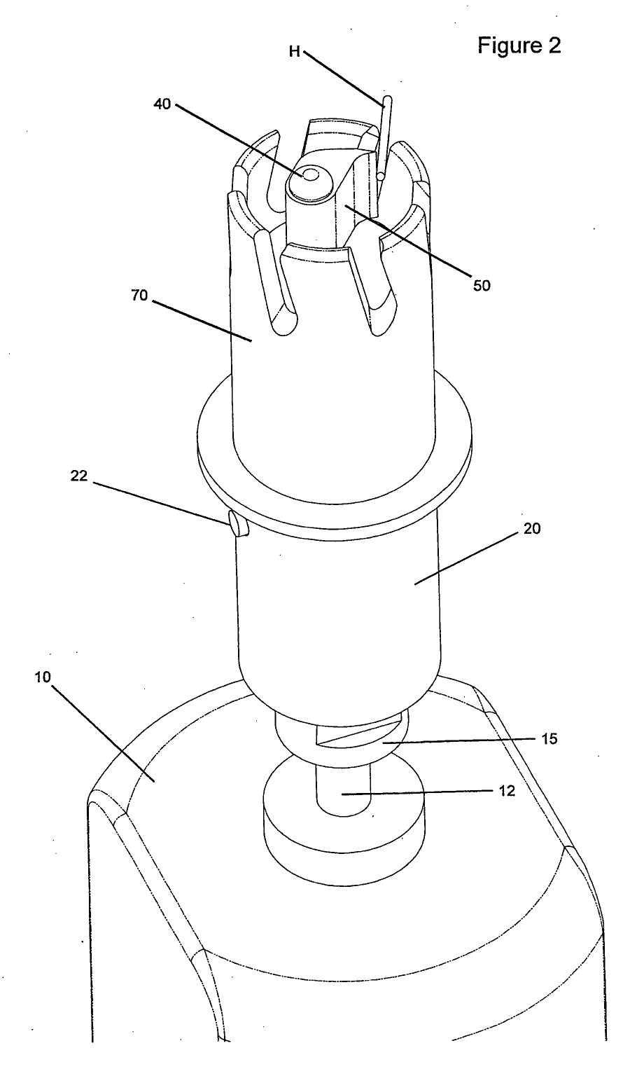

FIG. 2 is an assembled view showing motor 10, rotating motor shaft 12, motor coupling 15, rotor coupling 20, rotor fixing pin 22, blade support 40, rotating blade 50, static blade 70, and a hair bristle H.

In this illustrated embodiments, rotating blade 50 is freely rotatable on movable blade support 40. From the present description, those skilled in the art will appreciate that advantages of the present invention can be obtained without requiring the rotating blade to rotate freely around the movable blade support 40. It is only required that the blade edge move through a very small angle so that the contact pressure and/or position of the blade edge relative to the interior surface of the shell can change. For example, the angle of the cutting edge to the interior surface can hinge within about a few degrees or greater. From the present description and drawings, those skilled in the art will appreciate that the eccentric position of movable blade support 40 in rotating rotor 30 will move the longitudinal axis of movable blade support 40, which has a longitudinal axis substantially parallel to the longitudinal axis of motor shaft 12, through a generally circular path. This circular movement of movable blade support 40 will cause centrifugal force to act upon rotating blade 50, e.g. in a direction perpendicular to a tangent to the path of movable blade support 40, thereby causing rotating blade 50 to move outwardly and toward stationary blade 70.

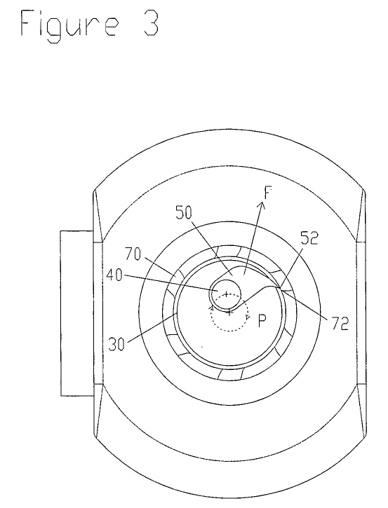

The actual cutting operation of this embodiment of the present invention is best illustrated in FIG. 3. With reference to FIG. 3, when motor 10 is actuated movable blade support 40 is moved so that its longitudinal axis passing through the center of the movable blade support 40 moves in a circular path indicated by dotted lines P in a clockwise direction. This causes centrifugal force to act upon rotating blade 50 as indicated by arrow F. FIG. 3 is merely for purposes of illustration and is not meant to indicate the exact position of forces acting upon rotating blade 50. The centrifugal force F will tend to keep the rotating blade 50 of this illustrated embodiment in contact with the interior surface of stationary blade 70. In the manner illustrated, cutting edge 52 of rotating blade 50 moves along the interior surface 71 of blade 70 and cooperates with cutting edges 72 of stationary blade 70 in order to cut hair. When a hair H is contacted by cutting edge 52, as shown in FIG. 2, the resistance to the movement of the cutting edge 52 will tend to wedge the entire rotating blade 50 more tightly between movable blade support 40 and stationary blade 70 thereby increasing the contact pressure between rotating blade 50 and stationary blade 70. Greater contact pressure reduces the likelihood that the cutting edge 52 will slide over a hair and not cut the hair as desired.

From FIG. 3, it will also be appreciated that cutting edge 52 precedes or is generally positioned ahead of the center of gravity of rotating blade 50 relative to the rotation of the blade around the interior of stationary blade 70. The cutting edge 52 also contacts the stationary blade 70 forwardly of the point of shortest distance between the center of rotating blade shaft 40 and stationary blade 70. This forward or preceding positioning of cutting edge 52, results in greater contact pressure between rotating blade 50 and stationary blade 70 when cutting edge 52 encounters resistance, e.g. from hair.

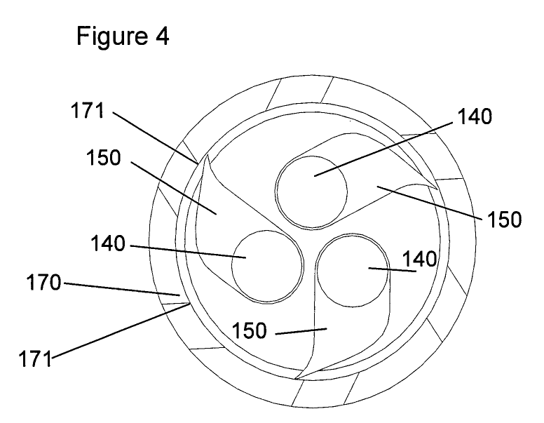

FIG. 4 illustrates an alternative embodiment of the present invention comprising three rotating blades 150 movably disposed within a stationary blade shell 170 having cutting edges 171. This embodiment is similar to the embodiment shown in FIGS. 1-3 with the exception that it comprises three movable blades 150 connected to three rotating blade supports 140 for movement within stationary blade shell 170.

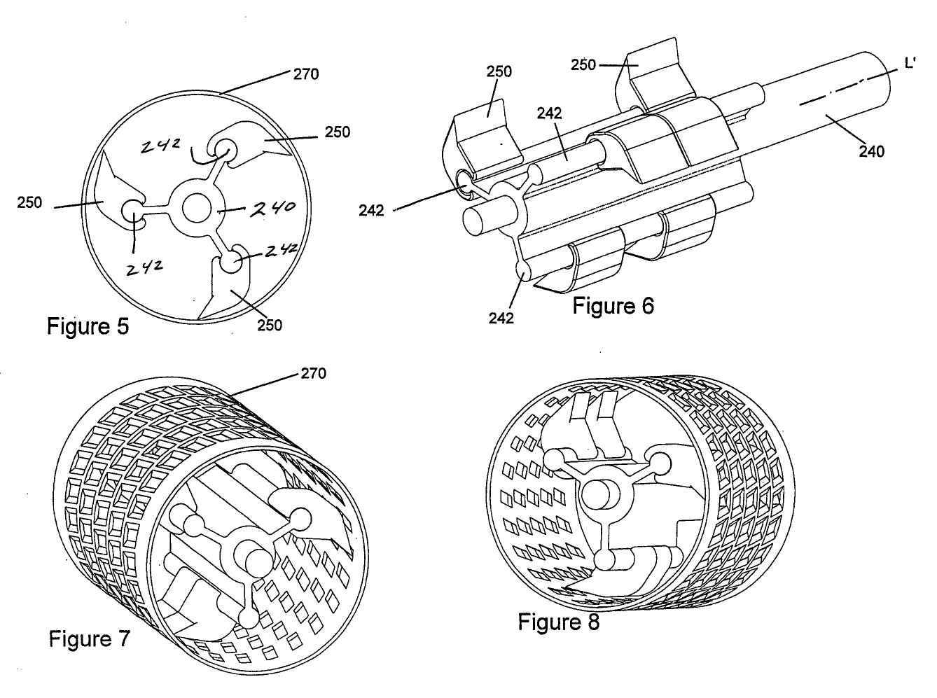

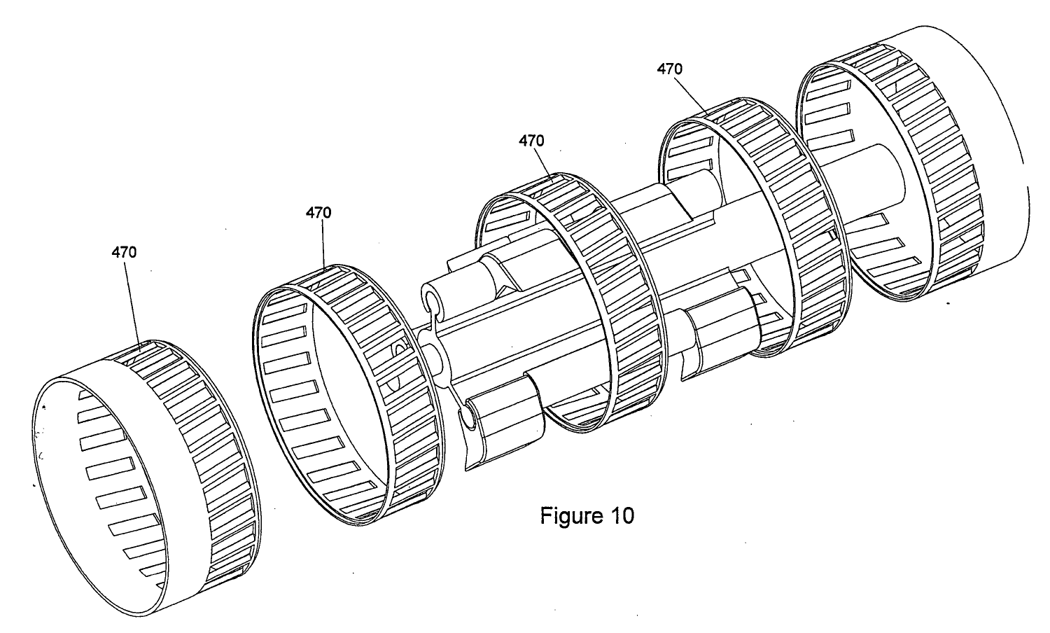

An alternative embodiment comprising a plurality of movable blades 250 in a form suitable for a shaver is illustrated in FIGS. 5-8. In this illustrated embodiment, rotating blade support 240 comprises three integrated hinges 242 for hingedly supporting movable blades 250. As best shown in FIG. 6, in this illustrated embodiment each hinge 242 supports a plurality of movable blades 250. While six blades are illustrated, a greater or lesser number of blades can be used. Unlike the arrangement of rotating blade 50 and movable blade support 40 shown in FIG. 1, from the present drawings it will be appreciated that blades 250 are not free to rotate entirely around each blade support hinge 242. Nonetheless, blades 250 can rotate sufficiently on hinge supports 242 as rotating blade support 240 is moved when longitudinal axis L′ is moved in a circular path within shell 270. Hinging blades 250 are advantageously positioned on hinge supports 242 in a generally balanced manner to minimize vibration of the entire device as blades 250 are moving within stationary shell 270. FIG. 10 illustrates a partially exploded view of a further embodiment, similar to the embodiment shown in FIGS. 5-8, but wherein the shell comprises multiple shell segments 470.

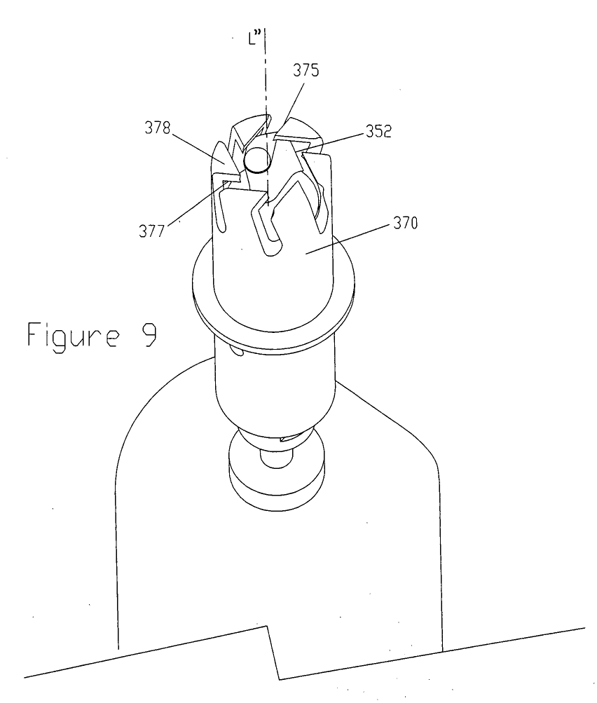

FIG. 9 illustrates a still further embodiment of the present invention wherein the cutting edge 352 of rotating blade 350 is disposed at an angle to longitudinal axis L″. Those skilled in the art will appreciate that it is preferable to have the cutting edge of the rotating blade contact a cutting edge of the stationary blade at an angle to provide a more scissor-like cutting action to hair rather than at a straight angle to provide a chopping action. This, of course, can be accomplished by having cutting edges of the stationary blade disposed at angles to the longitudinal axis of the blade support while keeping the cutting edge of the movable blade substantially parallel to that longitudinal axis, by having the cutting edge of the movable blade at an angle other than parallel to the longitudinal axis with the cutting edges of the stationary shell substantially parallel to the longitudinal axis, or having the cutting edges of both the movable blade and stationary cutting edges disposed at angles to each other. FIG. 9 also illustrates a feature of the present invention wherein slots 375 having cutting edges 377 are provided in the distal end 378 of shell 370.

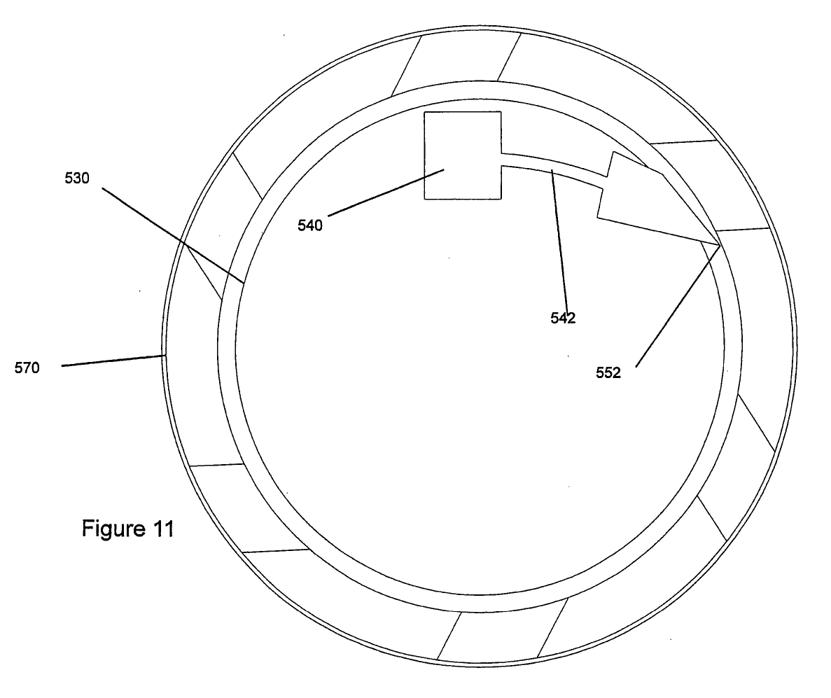

While the previously illustrated embodiments can provide the desired hinging or rotating action with elements formed of rigid materials, according to other embodiments, the hinging action which results in greater contact pressure between the movable blade and stationary blade is provided, at least in part, by utilizing flexible and/or resilient materials in the construction of the movable blades and/or movable blade supports. FIG. 11 illustrates an example of an embodiment of the present invention comprising a resilient blade support. According to this illustrated embodiment, a rotating blade having blade edge 552 is connected by a resilient arm 542 to movable blade support 540. As movable blade support 540 is moved around the interior of this illustrated shell, centrifugal force urges blade edge 552 into contact with the shell. As in the other disclosed embodiments, resistance to the movement of blade edge 552 along the interior surface of the shell will tend to increase the contact pressure between the blade edge 552 and the shell. As used herein, the phrase “contact pressure” is used to indicate that there is pressure exerted in a direction which would create and/or increase the pressure between the cooperating cutting edges and/or surfaces. The term “contact pressure” as used herein is not limited to times when the blade edge, for example 552, is in actual contact with the illustrated shell. In certain circumstances, it is possible that a hair would cause a movable blade edge to move off of the interior surface of the shell, though this could result in less than optimum performance. The resilient arm 542, blade and/or blade support 540 can be formed using metallic, polymeric and/or other suitably resilient material(s).

By providing designs with a lower contact pressure between the movable blade(s) and the opposing cutting edge, e.g. “stationary” cutting edge, when the devices are not cutting hair, the various embodiments of the present invention reduce noise, and increase battery life and blade edge life. The described wedging action is designed to provide a more reliable cutting action and is less likely to result in a blade edge slipping over a hair and consequently exerting an uncomfortable pulling action.

1. An electric hair trimmer comprising:
at least one shell comprising at least one hole through which hair can extend and comprising an interior cutting edge;
at least one movable blade hinge comprising a generally longitudinal axis, wherein said longitudinal axis of said hinge moves in a path defining a closed curve; and
at least one blade hingedly connected to said movable blade hinge, said blade comprising at least one blade cutting edge which is urged into contact with said interior cutting edge and which moves along a cutting path;
said interior cutting edge, said hinge and said blade positioned relative to said cutting path such that resistance encountered by said blade edge will tend to increase contact pressure between said blade cutting edge and said interior cutting edge.

2. An electric hair trimmer according to claim 1 wherein said blade cutting edge is urged into contact with said interior surface by centrifugal force.

3. An electric hair trimmer according to claim 1 wherein said electric hair trimmer is a nose hair trimmer.

4. An electric hair trimmer according to claim 3 wherein said shell is dimensioned to be received at least partially within a nasal cavity.

5. An electric hair trimmer according to claim 1 wherein said longitudinal axis of said movable blade hinge moves in a circular path.

6. An electric hair trimmer according to claim 1 wherein said hole defines said interior cutting edge.

7. An electric hair trimmer according to claim 1 wherein said shell comprises a plurality of holes.

8. An electric hair trimmer according to claim 7 wherein said holes define interior cutting edges.

9. An electric hair trimmer according to claim 1 comprising a motor connected to said movable blade hinge.

10. An electric hair trimmer according to claim 9 further comprising means for adjusting the speed of said motor whereby increased motor speed will increase said contact pressure.

11. An electric hair trimmer according to claim 9 wherein said motor comprises a housing and said shell is stationary relative to said motor housing.

12. An electric hair trimmer according to claim 1 wherein said blade rotates about said longitudinal axis.

13. An electric hair trimmer according to claim 1 wherein said cutting path is generally perpendicular to said longitudinal axis.

14. An electric hair trimmer comprising:
at least one stationary shell comprising at least one interior cutting edge and at least one hole through which hair can extend;
at least one movable blade hinge comprising a generally longitudinal axis, wherein said longitudinal axis of said hinge moves in a path defining a closed curve; and
at least one blade hingedly connected to said movable blade hinge, said blade comprising at least one cutting edge which is urged toward said interior cutting edge and moved along a cutting path which is generally perpendicular to said longitudinal axis.

15. An electric hair trimmer according to claim 14 wherein said blade is hingedly connected to said movable blade hinge and freely movable through at least a predetermined angle such that resistance encountered by said blade will tend to increase contact pressure between said blade cutting edge and said interior cutting edge.

16. An electric hair trimmer according to claim 14 wherein said longitudinal axis of said movable blade hinge moves through a circular path.

17. An electric hair trimmer according to claim 14 wherein said hole defines said cutting edge.

18. An electric hair trimmer according to claim 14 wherein said shell comprises a plurality of holes.

19. An electric hair trimmer according to claim 18 wherein said holes define cutting edges.

20. An electric hair trimmer according to claim 19 wherein at least one of said holes extends generally perpendicular to said longitudinal axis.

21. An electric hair trimmer according to claim 19 wherein at least one of said holes extends at an angle which is not generally perpendicular to said longitudinal axis.

22. An electric hair trimmer according to claim 14 wherein said electric hair trimmer is a nose hair trimmer.

23. An electric hair trimmer according to claim 22 wherein said shell is dimensioned to be received at least partially within a nasal cavity.

24. An electric hair trimmer according to claim 22 wherein said blade is hingedly connected to said movable blade hinge and freely moveable through at least a predetermined angle such that resistance encountered by said blade edge will tend to increase contact pressure between said blade cutting edge and said interior cutting edge.

25. An electric hair trimmer according to claim 22 wherein said longitudinal axis of said movable blade shaft moves through a circular path.

26. An electric hair trimmer according to claim 22 wherein said hole defines a cutting edge.

27. An electric hair trimmer according to claim 22 wherein said hinge comprises a shaft.

28. An electric hair trimmer according to claim 22 wherein said cutting edge is urged into contact with said interior surface by centrifugal force.

29. An electric hair trimmer according to claim 14 wherein said electric hair trimmer comprises a plurality of said moveable hinges and at least one blade hingedly connected to each of said hinges.

30. An electric hair trimmer according to claim 14 wherein said electric hair trimmer comprises a plurality of said moveable hinges and a plurality of blades hingedly connected to at least one of said hinges.

31. An electric hair trimmer according to claim 14 wherein said electric hair trimmer comprises a plurality of said moveable hinges and a plurality of blades hingedly connected to each of said hinges.

32. An electric hair trimmer according to claim 14 wherein said stationary shell comprises a plurality of segments.

33. An electric hair trimmer according to claim 14 wherein at least one of said blade hinge and said blade comprise a resilient material.

34. An electric hair trimmer according to claim 14 wherein said cutting edge is not parallel to said generally longitudinal axis of said movable hinge.

35. An electric hair trimmer comprising:
at least one shell defining an interior surface and comprising at least one hole through which hair can extend, said shell comprising a generally circular cross-section;
at least one blade movably disposed within said shell and means for moving said blade which moves within said shell, said blade movably connected to said moving means, said blade comprising at least one cutting edge which moves along a cutting path and is urged into contact with said interior surface;
wherein said cutting edge and said moving means move within said shell such that the angular position of said cutting edge precedes the angular position of said moving means relative to a point at the center of said cutting path.

36. An electric hair trimmer according to claim 35 comprising at least one movable blade hinge comprising a generally longitudinal axis, wherein said longitudinal axis of said hinge moves in a path defining a closed curve; and
wherein said blade is hingedly connected to said movable blade hinge and freely movable through at least a predetermined angle such that resistance encountered by said blade edge will tend to increase contact pressure between said blade cutting edge and said interior cutting edge.

37. An electric hair trimmer according to claim 35 wherein said longitudinal axis of said movable blade hinge moves through a circular path.

38. An electric hair trimmer according to claim 35 wherein said shell comprises a plurality of holes.

39. An electric hair trimmer according to claim 35 wherein said electric hair trimmer is a nose hair trimmer.

40. An electric hair trimmer according to claim 39 wherein said shell is dimensioned to be received at least particularly within a nasal cavity.

41. An electric hair trimmer according to claim 35 wherein said moving means comprises a shaft having a longitudinal axis which moves through a circular path.

42. An electric hair trimmer according to claim 35 wherein said electric hair trimmer comprises a plurality of said moveable hinges and at least one blade hingedly connected to each of said hinges.

43. An electric hair trimmer according to claim 35 wherein said electric hair trimmer comprises a plurality of said moveable hinges and a plurality of blades hingedly connected to at least one of said hinges.

44. An electric hair trimmer according to claim 35 wherein said electric hair trimmer comprises a plurality of said moveable hinges and a plurality of blades hingedly connected to each of said hinges.

45. An electric hair trimmer according to claim 35 wherein said stationary shell comprises a plurality of segments.

46. An electric hair trimmer according to claim 35 wherein at least one of said blade hinge and said blade comprise a resilient material.

47. An electric hair trimmer according to claim 35 wherein said cutting edge is not parallel to said generally longitudinal axis of said movable hinge.

48. An electric hair trimmer according to claim 35 wherein said cutting edge is urged into contact with said interior surface by centrifugal force.

49. An electric hair trimmer comprising:
at least one shell defining an interior surface and comprising at least one hole through which hair can extend;
at least one movable blade hinge comprising a generally longitudinal axis, wherein said longitudinal axis of said hinge moves in a path defining a closed curve;
at least one blade hingedly connected to said movable blade hinge, said blade comprising at least one cutting edge which is urged into contact with said interior surface;
wherein at least one point of contact between said blade and said interior surface precedes the closest point between said blade hinge and said shell such that resistance encountered by said blade edge will tend to increase contact pressure between said blade cutting edge and said interior cutting edge.

50. An electric hair trimmer according to claim 49 wherein said blade is hingedly connected to said movable blade hinge and freely movable through at least a predetermined angle and wherein said cutting edge is urged into contact with said interior surface by centrifugal force.

51. An electric hair trimer according to claim 50 wherein said longitudinal axis of said movable blade shaft moves through a circular path.

52. An electric hair trimmer according to claim 49 wherein said shell comprises a plurality of holes.

53. An electric hair trimmer according to claim 49 wherein said electric hair trimmer is a nose hair trimmer.

54. An electric hair trimmer according to claim 49 wherein said shell is dimensioned to be received at least particularly within a nasal cavity.

55. An electric hair trimmer according to claim 49 wherein said hinge comprises a shaft.

56. An electric hair trimmer according to claim 49 wherein said electric hair trimmer comprises a plurality of said moveable hinges and at least one blade hingedly connected to each of said hinges.

57. An electric hair trimmer according to claim 49 wherein said electric hair trimmer comprises a plurality of said moveable hinges and a plurality of blades hingedly connected to at least one of said hinges.

58. An electric hair trimmer according to claim 49 wherein said electric hair trimmer comprises a plurality of said moveable hinges and a plurality of blades hingedly connected to each of said hinges.

59. An electric hair trimmer according to claim 49 wherein said stationary shell comprises a plurality of segments.

60. An electric hair trimmer according to claim 49 wherein at least one of said blade hinge and said blade comprise a resilient material.

61. An electric hair trimmer according to claim 49 wherein said cutting edge is not parallel to said generally longitudinal axis of said movable hinge.

62. An electric hair trimmer comprising:
at least one shell comprising at least one hole through which hair can extend, an interior cutting edge, said shell comprising a generally circular cross-section and a longitudinal axis;
at least one blade movably disposed within said shell, said blade having a cutting edge and a center of gravity;
means for moving said blade within said shell, said blade hingedly connected to said moving means and hinging about a movable axis substantially parallel to said longitudinal axis;
wherein at least one point of contact between said cutting edge and said shell precedes the rotational position of said center of gravity as said blade moves relative to said interior surface.

63. An electric hair trimmer according to claim 62 wherein a major portion of said cutting edge of said blade precedes said center of gravity as said blade moves relative to said interior surface.

64. An electric hair trimmer according to claim 62 wherein substantially all of said cutting edge of said blade precedes said center of gravity as said blade moves relative to said interior surface.

65. An electric hair trimmer according to claim 62 wherein all of said cutting edge of said blade precedes said center of gravity as said blade moves relative to said interior surface.

66. An electric hair trimmer according to claim 62 wherein said moving means comprises a shaft having a longitudinal axis which moves through a circular path.

67. An electric hair trimmer according to claim 62 wherein said moving means comprises a movable blade hinge.

68. An electric hair trimmer according to claim 62 wherein said electric hair trimmer is a nose hair trimmer.

69. An electric hair trimmer according to claim 68 wherein said shell is dimensioned to be received at least partially within a nasal cavity.

70. An electric hair trimmer according to claim 62 wherein said blade is hingedly connected to said movable blade hinge and freely moveable through an angle of at least 10°.

71. An electric hair trimmer according to claim 62 wherein said blade is hingedly connected to said movable blade hinge and freely moveable through an angle of at least 20°.

72. An electric hair trimmer according to claim 62 wherein said blade is hingedly connected to said movable blade hinge and freely moveable through an angle of at least 30°.

73. An electric hair trimmer according to claim 49 wherein said stationary shell comprises a plurality of segments.

74. An electric hair trimmer according to claim 49 wherein at least one of said blade hinge and said blade comprise a resilient material.

75. An electric hair trimmer according to claim 49 wherein said cutting edge is not parallel to said generally longitudinal axis of said movable hinge.

76. An electric hair trimmer according to claim 61 wherein said interior cutting edge, said hinge and said blade are positioned relative to said cutting path such that resistance encountered by said blade edge will tend to increase contact pressure between said blade cutting edge and said interior cutting edge.
